(19) United States
(12) Patent Application Publication
(10) Pub. No.: US 2019/0344848 A1
(43) Pub. Date: Nov. 14, 2019

(54) Holding Device For Bicycles, Bicycle Holding Device, And Method For Parking A Bicycle In A Held Position

(71) Applicant: KOCHERSCHEIDT, SCHILLER, SIMON UND THIELE GBR, Uhingen (DE)

(72) Inventor: Tobias KOCHERSCHEIDT, Albershausen (DE)

(73) Assignee: KOCHERSCHEIDT, SCHILLER, SIMON UND THIELE GBR, Uhingen (DE)

(21) Appl. No.: 16/305,645

(22) PCT Filed: Jun. 1, 2017
(86) PCT No.: PCT/EP2017/063377

§ 371 Date: Nov. 29, 2018

(30) Foreign Application Priority Data
Jun. 2, 2016 (DE) 20 2016 003 500.3

(51) Int. Cl. B62H 3/04

(52) U.S. Cl. CPC B62H 3/04

(57) ABSTRACT

A brush-based holding device for bicycles (2) of different sizes and tire thicknesses, wherein brushes (12, 14) are fastened opposite each other on a mounting (10) to accommodate different tire thicknesses and permanently hold a bicycle in a compact manner in an upright position on the rear wheel against the wall (4).

The invention relates to a holding device for bicycles, a bicycle holding device and a method for parking a bicycle in a held position.

Bicycle holders of conventional or known construction for compact parking for an extended period have hooks, rails or similar devices into which a bicycle must be hung with a certain application of force or must even be lifted. Depending on the type of fastening, even older children may require the assistance of adults to get to their bicycles. A compact holder for bicycles of different sizes and above all for different tire thicknesses that is easy for children to operate without removing parts of the bicycle currently does not exist.

The invention described in claim 1 therefore addresses the problem of creating a bicycle holder that is easy to operate both for children and for adults and is capable primarily of accommodating different tire thicknesses (racing bikes, mountain bikes, city bikes etc.) and frame sizes without having to replace parts.

This problem is resolved with the combination of features described in claim 1. According to the invention, a holding device described in claim 4 is also proposed. In addition, a bicycle holding device described in claim 13 or 14 is also proposed. A method according to the invention is defined in claim 15. The dependent claims define several examples of the invention.

The invention therefore proposes in particular a holding device for bicycles that has: a mount and a plurality of bristles or blades that are mounted on the mounting, whereby the mounting forms two facing holder sections, between which there is a space to accommodate a wheel of a bicycle, and whereby at least a part, i.e. at least some, of these bristles extend with their free ends into the space.

In particular the bristles or blades thereby project into the space described above to hold or to stabilize the wheel of the bicycle.

The bristles or blades can interact with the mount and/or the supporting structures described below to exercise a supporting function for the bicycle by means of the wheel of the bicycle, if a bicycle is positioned appropriately with one of its wheels in the space described above. In particular, the bicycle can be in contact by means of one of its wheels only with the bristles or blades when it is positioned with one wheel in the space between the holder sections. Alternatively, the bicycle can be in contact by means of one of its wheels with the bristles or blades and the holder sections or by means of one of its wheels with the bristles or blades and the supporting structures described below.

Preferably, the bristles or blades are fastened with one end to one of the facing holder sections or to a support body, whereby the respective facing end of these bristles or blades is a free end. However, the bristles can also be threaded through a U-shaped channel or an arrangement of two openings next to each other, the opening cross-sections of which are essentially parallel and/or in a plane, so that the two free ends of a bristle lie in the same direction and project into the space described above, which is provided to accommodate a wheel. The respective arrangement of the two openings and/or of the U-shaped channel can thereby be provided, for example, on one of the facing holder sections or on a supporting structure.

In one particularly advantageous embodiment, first bristles or blades of the plurality of bristles or blades extend from the direction of and/or from one of the two facing holder sections with their free ends into the space which is provided to accommodate the wheel of a bicycle between two facing holder sections, and two bristles or blades of the plurality of bristles or blades extend from the direction of and/or from the other of the two facing holder sections into this space, which is provided to accommodate a wheel of a bicycle between two facing holder sections.

This is true in particular for the bristles when they are free of any application of external forces, i.e. in particular for a state in which no wheel of a bicycle has been introduced into the space to accommodate a wheel of a bicycle.

The bristles or blades are specifically and in particular deformable, in particular elastically deformable, whereby the restoring forces that occur during the deformation of the bristles or blades are used to hold a wheel of the bicycle (and therefore the bicycle itself), when a wheel is introduced into the space. The holder or sections or parts of the holder can also be designed so that they are elastic, to support such a holding of the wheel, in particular to continue to hold the wheel, and specifically in particular when the wheel, in particular in its axial direction, has dimensions that are sufficient to apply a load to the holder or parts or sections of the holder so that they deform this holder or these parts or these sections (elastically).

For example, the bristles can be provided in the form of bundles, so that a plurality of bristles can be arranged in bundles. However, the bristles or blades can also be provided individually. The bristles or blades can thereby be located at regular intervals. Alternatively, the bristles or blades can also be located at irregular intervals.

Bristles or blades or all bristles or blades in the state in which no (external) load is applied can be oriented essentially parallel to one another.

All the bristles or blades can also be of the same length.

In one preferred configuration, however, bristles or blades of different lengths can be provided. For example, bristles or blades of exactly two different lengths can be provided, or bristles or blades of exactly three different lengths can be provided, or bristles or blades of exactly four different lengths can be provided or bristles or blades of exactly five different lengths can be provided, or bristles or blades of exactly six different lengths can be provided, or bristles or blades of exactly seven different plates can be provided, or bristles or blades of exactly eight different lengths can be provided, or bristles or blades of exactly nine different lengths can be provided, or bristles or blades of exactly ten different lengths can be provided, or bristles or blades of more than 10 different lengths can be provided.

First bristles or blades of different lengths can be provided, as well as second bristles or blades of different lengths. It should be noted that within the meaning of the present application in particular the first bristles or blades extend from one of the holder sections with at least one free end into the space between the holder sections, and the second bristles or blades extend from the direction of the other, facing holder section with that we at least one free end into the space between the holder sections.

For example, the first bristles or blades of a first length and first bristles or blades of a second length that is different from the first length can be provided. Furthermore, second bristles or blades of a third length and second bristles or blades of a fourth length that differs from the third length can be provided. For example, the first length can be equal to the third length and/or the second length can be equal to the fourth length. The second length can be between 0.3 and 0.8, e.g. between 0.4 and 0.6, e.g. 0.5 of the first length, and/or the fourth length can be between 0.3 and 0.8, e.g. between 0.4 and 0.6, e.g. 0.5 of the third length.

The thicknesses or diameters of all the bristles or blades can be identical. However, the bristles and plates can also have different diameters or thicknesses.

For example, the number of bristles of the holding device can be greater than 20, preferably greater than 40, preferably greater than 60, preferably greater than 80, preferably greater than 100, preferably greater than 150, preferably greater than 200, preferably greater than 250, preferably greater than 300, preferably greater than 400, preferably greater than 500, preferably greater than 600, preferably greater than 700, preferably greater than 800, preferably greater than 900, preferably greater than 1000.

The number of the first bristles of the holding device can be greater than 10, preferably greater than 20, preferably greater than 30, preferably greater than 40, preferably greater than 50, preferably greater than 75, preferably greater than 100, preferably greater than 125, preferably greater than 150, preferably greater than 200, preferably greater than 250, preferably greater than 300, preferably greater than 250, preferably greater than 400, preferably greater than 450, preferably greater than 500.

The number of the second bristles of the holding device can be greater than 10, preferably greater than 20, preferably greater than 30, preferably greater than 40, preferably greater than 50, preferably greater than 75, preferably greater than 100, preferably greater than 125, preferably greater than 150, preferably greater than 200, preferably greater than 250, preferably greater than 300, preferably greater than 350, preferably greater than 400, preferably greater than 450, preferably greater than 500.

For example, the first bristles can be distributed and/or located in bundles on a surface that is smaller than 1000 cm² and larger than 25 cm², preferably smaller than 800 cm² and larger than 25 cm², preferably smaller than 600 cm² and larger than 25 cm², preferably smaller than 400 cm² and larger than 25 cm², preferably smaller than 300 cm² and larger than 25 cm², preferably smaller than 250 cm² and larger than 40 cm², preferably smaller than 150 cm² and larger than 40 cm². The area is thereby determined by the shortest line around all the first bristles.

For example, the second bristles can be distributed and/or located in bundles on a surface that is smaller than 1000 cm² and larger than 25 cm², preferably smaller than 800 cm² and larger than 25 cm², preferably smaller than 600 cm² and larger than 25 cm², preferably smaller than 400 cm² and larger than 25 cm², preferably smaller than 300 cm² and larger than 25 cm², preferably smaller than 250 cm² and larger than 40 cm², preferably smaller than 150 cm² and larger than 40 cm². The area is thereby determined by the shortest line around all the second bristles.

Between the first bristles or the free ends of the first bristles or blades and the second bristles or free ends of the second bristles or blades, a bristle-free or blade-free space can be provided, and specifically viewed in the direction of the longitudinal extension of these bristles or blades in the state in which no external load is being applied.

Alternatively or additionally, a plurality of or all the first bristles or blades can overlap with a plurality or all of the second bristles or blades, and specifically in the direction of the longitudinal extension of these first bristles or blades and/or in the direction of the longitudinal extension of the second bristles or blades viewed in the state in which no external load is being applied to the bristles or blades.

For example, first bristles or blades and second bristles or blades can overlap between 1% and 75% of the length of the first bristles, preferably between 1% and 60% of the length of the first bristles or blades, preferably between 1% and 50% of the length of the first bristles, preferably between 1% and 40% of the length of the first bristles or blades, preferably between 10% and 40% of the length of the first bristles or blades, preferably between 20% and 40% of the length of the first bristles or blades, preferably approximately ⅓ of the length of the first bristles or blades, whereby the length of the first bristles or blades in this sense is in particular the length of the exposed section of these first bristles or blades, i.e. the length that is outside their fastening points or anchoring points.

One portion of the first and second bristles or blades can also overlap, while another portion of the first bristles or blades can be at some distance from another portion of the second bristles or blades, forming the above-mentioned intervening space.

The first bristles or blades or some of the first bristles or blades and the second bristles and blades or some of the second bristles and blades can be located with their free ends abutting one another.

The mounting of the holding device can be formed by means of a U-shaped part or is a U-shaped part, whereby this U-shaped part is formed by two facing legs and by a leg that runs transverse to these facing legs and tis connecting leg connects these two facing legs. For example, a holding device of this type can be made of flat rolled steel. However, other materials, such as plastic or wood or another metal, are preferred. For example, the U-shaped mounting can be formed from composite fiber material.

The U-shaped part—if one is present in a preferred configuration—can be shaped, for example, so that the material thickness along the U-shape is less, in particular significantly less, then the depth perpendicular to the U-shape or perpendicular to the plane that is spanned by the U-shape. In other words, in an overhead view of a U-shaped end surface of the U-shaped part, the material thickness in the vicinity of the two facing legs as well as of the connecting leg, which can be constant, for example, is less than the depth that extends between the above-mentioned end surface and the other U-shaped end surface. For example, the above-mentioned depth can be greater than 5 times, preferably greater than 8 times, greater than 10 times, greater than 15 times the above-mentioned thickness or maximum thickness (if the thickness varies).

The length of the facing legs of the U-shaped part can, for example, be greater than 5 times, preferably greater than 8 times, greater than 10 times, greater than 15 times the above-mentioned thickness or—if in some embodiments the thickness is not constant—maximum thickness (if the thickness varies). The length of the facing legs of the U-shaped part is thereby the dimension facing away from the connecting leg or is the length perpendicular to the above mentioned thickness of the leg in question and perpendicular to the above mentioned depth of the leg in question.

The connecting leg can be provided with a mounting device and/or with one or more mounting holes, which can be in the form of through holes, for example. Such through-holes can be provided each for an individual screw, by means of which the holding device can, for example, be fastened to a wall, in particular to a vertical wall or to a floor or to a section of floor covering, such as a flooring element, for example.

Alternatively or additionally, however, other types of fastening elements or another type of mounting device can be provided for the fastening of the holding device to a vertical wall or to a floor or to a floor covering section. This mounting method can be used for the holding device that is provided with a U-shaped part as well as for holding devices that do not have a U-shaped part.

The holding device according to the invention can also advantageously have two L-profiles, each of which forms a first leg and a second leg that lies perpendicular to the respective first leg. The first legs of the two L-profiles can thereby be two legs facing each other, i.e., the two L-profiles can be oriented relative to each other so that the first legs of the two L-profiles form two facing legs that are separated from each other, e.g. parallel to each other, between which there is the space to accommodate a wheel of a bicycle. These first legs of the two L-profiles can thereby form the two facing holder sections or components of the holder sections.

The two L-profiles can be held by means of the second leg, and specifically, for example, to a vertical wall or to a floor or to a section of floor covering, such as a flooring element for example. For this purpose, for example, the legs of the two L-profiles can be provided with a mounting device and/or with one or more mounting holes, which can be configured, for example, in the form of through holes. Through holes of this type can each be provided for a screw, by means of which the holding device or the two L-profiles of the holding device can be fastened, for example, to a wall, in particular to a vertical wall or to a floor or to a floor covering section such as a flooring element, for example.

The first legs of the two L-profiles can be oriented essentially parallel to each other at a distance (at a right angle to the direction of their longitudinal extension), and the two legs can thereby be oriented so that, for example, they are flush with one another. Second legs that are flush with one another of this type can, for example, be oriented with their free ends facing each other, or they can be oriented with their free ends facing away from each other.

Instead of a U-shaped or two L-shaped parts, however, parts in other shapes can also be provided that have two parallel legs with a space formed between them to accommodate a wheel of the bicycle, such as a plate, for example, on which the two parallel legs are provided, or a ring from which the two parallel legs project perpendicular to the plane spanned by them. A holding part can thereby be provided, as in the two above examples the plate or the ring, that are used for the fastening of the holding device to a wall or to a floor or to a floor covering section, such as a flooring element, for example, and/or for the supporting connection of the two legs. This holder part can, for example, be provided on top with reference to the two legs or the connecting leg with holes, whereby it should be noted that these second legs or these connecting legs also form holding parts, for example.

The facing holder sections are preferably formed by facing legs or flanges, e.g. legs of a U-shaped part or leg of an L-shaped part.

As indicated above, the holding device can have a first structural body, on or in which the first bristles or blades are held or fastened (for short: are fastened). In addition, the holding device can have a first and a second structural body, in particular different from the first structural body, on or in which the second bristles or blades are held or fastened (for short: are fastened). The first structural body with the first bristles thereby forms in particular a first brush and the second structural body with the second bristles forms in particular a second brush. The first brush can be fastened to one of the facing legs, and the second brush can be fastened to the other of the facing legs, and specifically each on the side facing the space between the legs.

The first structural body is supported by a first of the two facing holder sections or legs of the mounting and the second structural body is supported by a second of the two facing holder sections or legs of the mounting.

The mounting can be designed so that is elastic, i.e. so that the two facing holder sections or legs of the holder and/or the two facing legs of the U-shaped part can move at least to some extent toward one another and/or away from one another. However, at least one elastic part can be located inside the mounting and/or between the two holder sections or legs or on the side facing the space to accommodate a wheel. In particular, a wheel introduced into the space can be elastically supported or clamped onto elastic elements of this type.

When in the framework of this application, the space (between the two facing holder sections) to accommodate a wheel of a bicycle is mentioned, it should be noted that it does not mean that the wheel (i.e. front wheel or rear wheel) can be fully accommodated in the space. In particular, the space is used for the insertion of a section of the wheel. For example, this space, which is defined by the facing holder sections or legs, can have a volume that is greater than 30 cm³ and less than 20,000 cm³, preferably greater than 30 cm and less than 20,000 cm³, preferably greater than 30 cm³ and less than 15,000 cm³, preferably greater than 30 cm³ and less than 10,000 cm³, preferably greater than 30 cm³ in less than 8000 cm³, preferably greater than 200 cm³ and less than 5000 cm³, preferably greater than 400 cm³ and less than 3000 cm³, preferably greater than 500 cm³ and less than 2000 cm³.

Bristles or blades are preferably longer than 1 cm and shorter than 20 cm, preferably longer than 2 cm and shorter than 18 cm, preferably longer than 3 cm and shorter than 15 cm, preferably longer than 4 cm and shorter than 12 cm, preferably longer than 5 cm and shorter than 10 cm.

The holder sections or legs facing each other preferably are at a distance from each other that is greater than 1 cm and less than 30 cm, preferably greater than 2 cm and less than 25 cm, preferably greater than 3 cm in less than 20 cm, preferably greater than 4 cm and less than 15 cm, preferably greater than 5 cm in less than 13 cm.

Preferably the supporting bodies and/or the first leg and/or the second leg and/or the bristles or blades are elastic.

The bristles or blades or the bristles of the brushes can be made of plastic, or can be natural bristles, or metal.

The supporting structures for the bristles or blades can be made of wood, for example, or plastic or metal.

The mounting construction or the mounting can be made of metal, for example, or plastic or wood.

The holder can be designed so that tires of different sizes can be held by the bristles of the brushes. The bristles or blades can have equal or different lengths and they can contact or overlap each other. The supporting construction or mounting is slightly flexible, for example (although it can also be rigid), and gives slightly when pressure is applied to the item being held (e.g. a tire). The mounting can be fastened to the wall by screws or adhesive, for example.

One mode of operation of the invention is explained below by way of example. The bicycle/the item is pressed between the brushes and is held in place by the restoring forces of the brushes and of the supporting structure or mounting. The bicycle can stand vertically or horizontally. In a horizontal position of a bicycle, the rear tire must be pushed into the holder.

According to the invention, a bicycle holding device is also provided with at least one floor covering section, and with a holding device for bicycles; this holding device is fastened by means of at least one fastening element (e.g. screw and/or clamp) to the at least one floor covering section (e.g. floor slab or ground or tiled area or asphalt area or concrete area or asphalt slab or concrete slab or wooden board or concrete paver or arrangement of concrete pavers or similar paving elements), and whereby the holding device is equipped as claimed by the invention.

The holding device for bicycles is preferably fastened and located so that the facing holder sections or legs are oriented at a right angle, preferably perpendicular, to the ground or to the floor covering section. The reason for this location and orientation is so that the space between the older sections is open on top, and in particular also laterally on the remaining two of four sides, which are (virtually) enclosed on their periphery by the holder sections.

According to the invention, a bicycle holding device is also provided with at least one upright wall, e.g. perpendicular or vertical (e.g. a fixed wall and/or, for example, a basement wall, building wall, or fixed on the floor or foundation in question etc.), and with a holding device for bicycles which is fastened to the upright wall in the manner claimed by the invention by means of at least one fastening element (e.g. screw and/or clamp).

According to an additional aspect of the invention—and the applicant reserves the right to claim this aspect in the course of the application proceeding—a bicycle holding device is provided that is in the form of a mobile bicycle holding device and is designed for support on a foundation, and has a holding device for bicycles which is designed in the manner claimed by the invention. This bicycle holding device can, for example, have a holding device according to the invention, which is supported on a slab or similar structure.

It goes without saying that the developments of the holding device according to the invention for bicycles that are disclosed in this application can also (in appropriate combination) be developments of the bicycle holding device according to the invention.

The invention further relates to a method for parking a bicycle in a held position, in which the bicycle is supported with one or both wheels of the bicycle on a floor and/or on a foundation, and in an essentially upright position with the following steps: provision of at least one holding device claimed by the invention for bicycles and/or at least one bicycle holding device according to the invention; introduction of a front wheel of a bicycle or a rear wheel of this bicycle into the space to accommodate the wheel of a bicycle; which is formed between the two facing older sections of the holding device for bicycles, whereby bristles or blades of the holding device come into contact with the introduced wheel of the bicycle in an upright position, whereby the bicycle, for the introduction of a front wheel of the bicycle or of the rear wheel of this bicycle, is held in the space for the accommodation of a wheel of the bicycle in supporting areas; removal from the bicycle in these supporting areas of the holding forces applied to introduce it, so that the bicycle continues to be held in an upright position by means of the floor or foundation and by means of the holding device.

The holding device claimed by the invention is suitable in particular for the performance of the method claimed by the invention.

It goes without saying that the holding device for bicycles that is used in the method according to the invention can also be designed as described in any one of the developments that are disclosed in this application.

The upright position of the bicycle is in particular a position in which the plane defined by the top and/or bottom tube, head tube and seat tube is essentially vertical or encloses an angle with the foundation that is greater than 45°, preferably greater than 60°, preferably greater than 70°, preferably greater than 80°.

The invention makes it possible to easily accommodate bicycles of different sizes entire thicknesses and also to remove them again without the need for additional handles.

One advantageous configuration of the invention is illustrated and explained in further detail with reference to the accompanying FIGS. 1, 2, 3 and 4, in which:

FIG. 1 shows the holding device in a plan view;

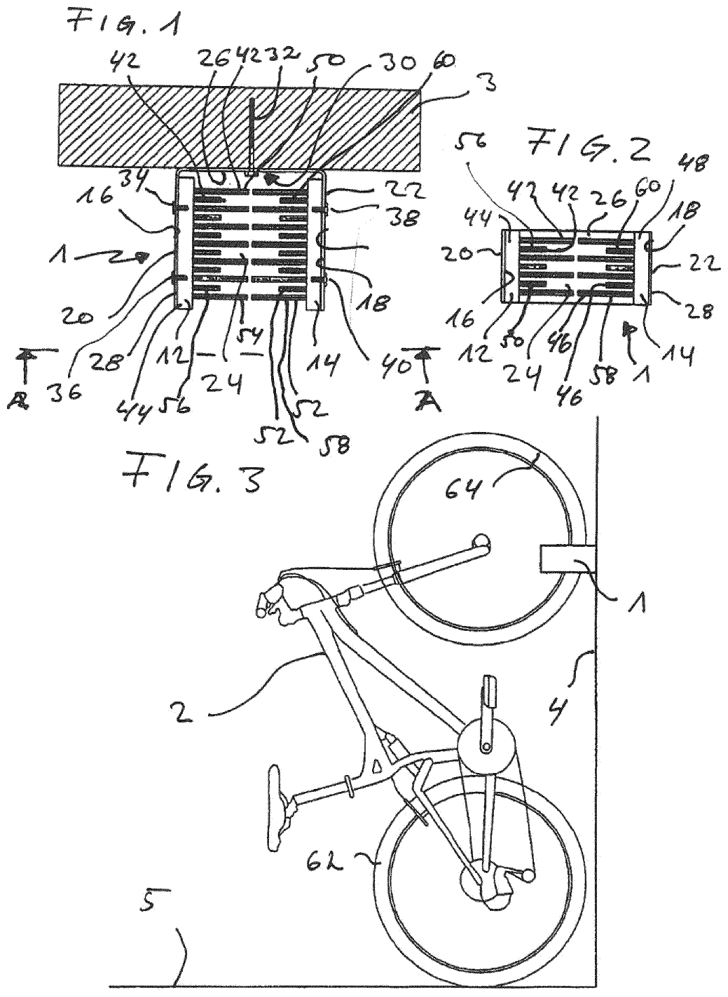

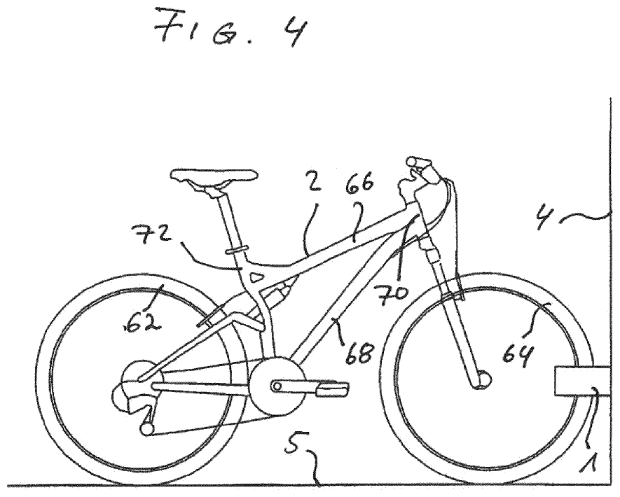

FIG. 2 shows the holding device in a front view (2);

FIG. 3 shows the position of the bicycle in the holder or holding device in a vertical position (3);

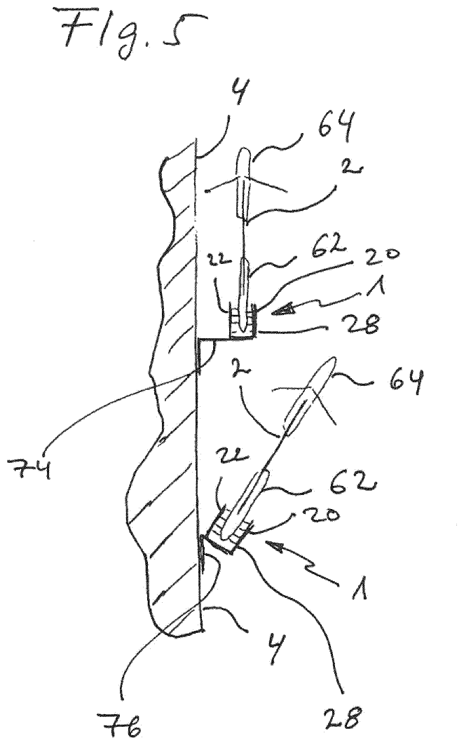

FIG. 4 shows the position of the bicycle in the holder or holding device in a horizontal position (4), and

FIG. 5 is an overhead view of two bicycles 2, each of which is held on a wall 4 by means of a holding device 1 according to the invention shown by way of example.

On the holding device illustrated in FIGS. 1 and 2 there are facing brushes, which depending on the design can also be of different lengths and can partly overlap on account of their facing position. The flexibility of the brushes and a certain flexibility of the mounting allows the introduction of bicycle tires of different sizes with the application of a relatively small amount of force. The combination of the number and different lengths of the brushes generates sufficient friction to hold a bicycle wheel stably on the wall or on the floor. With the application of only a small amount of force, which therefore makes the holder suitable for use by children, the bicycle can be removed from the holder by pulling it toward the user. In addition to bicycles, other everyday items such as garden tools, skateboards and similar items can also be held.

FIG. 1 shows in particular a holding device 1 for bicycles 2. The item 3 shown in FIG. 1—as is also apparent from a joint consideration of FIGS. 3 and 4,—can, for example, optionally be a wall 4 (see also FIG. 3) or a floor or floor covering element 5 (see also FIG. 4). In the first case, FIG. 1 shows an overhead view of the holding device 1, and in the second case FIG. 1 shows an overhead side view of the holding device 1.

The holding device 1 has a mounting 10, a first brush 12 and a second brush 14.

The mounting 10 is made of metal, although it can also be made of plastic, for example. In this case the mounting 10 is U-shaped and has two facing holder sections 16, 18, each of which is formed by a leg 20, 22, i.e. a first leg and a second leg 22. The legs 20, 22 extend essentially parallel to each other and are at a distance from each other so that between them they form a space 24 to accommodate a wheel of a bicycle.

The two facing legs 20, 22 are connected with each other on one of their respective ends by means of a connecting leg 26. Therefore the mounting 10 has a U-shaped part 28 formed by means of the legs 20, 22 and by means of the connecting leg 26 or is a U-shaped part.

The connecting leg is provided with one or more mounting holes 30 which are in the form of through holes, so that the holding device 1 can be fastened to the object 3 by means of (respective) mounting elements that extend through them, such as screws 32.

A first brush can be fastened to one of the facing legs 3 and the second brush can be fastened to the other of the facing legs, and specifically to the side facing the space between the legs. Screws 34, 36, 38, 40 can be provided for this purpose.

A first brush 12 has a plurality of first bristles 42 and a first supporting structure 44 to which or in which the first bristles 42 are fastened.

The second brush 14 has a plurality of second bristles 46 and a second supporting structure 48 to which or in which the second bristles 46 are fastened.

Here, the first bristles 42 and the second bristles 46 are each configured and grouped respectively into a first bristle bundle 50 and a second bristle bundle 52.

As FIGS. 1 and 2 clearly show, there are first bristles 42 of a first length 54 and first bristles 42 of a second length 56 which is different from the first length 54. There are also second bristles 46 of a third length 58 and second bristles 46 of a fourth length 60 which is different from the third length 58. The first length 54 is approximately equal to the third length 58 and the second length 56 is approximately equal to the fourth length 60. The second length 56 is here approximately half as long as the first length 54, with reference to the length of the bristles 42, 46 outside the first of the supporting structures 44.

The bristles 42, 46 are elastic. The mounting 10 is also elastic, and is designed so that the legs 20, 22 can be pressed elastically outward or away from each other (whereby the greatest distance is traveled in the vicinity of the free ends of the legs 20, 22).

FIG. 2 is a head-on view of FIG. 1 viewed from line A-A.

FIG. 3 shows a bicycle 2 in an upright position in which the bicycle 2 is supported on the floor 5 only with its rear wheel 62, while the front wheel 64 is accommodated in the space 24 of the holding device 1. The holding device 1 is here mounted on the floor 5.

FIG. 4 shows a bicycle 2 in an upright position in which the bicycle is supported on the floor 5 only with its front wheel 64 and with its rear wheel 62, while the front wheel 62 is accommodated and held in the space 24 of the holding device 1. Here the holding device 1 is mounted on the wall 4.

The bicycle also has a top tube 66, a bottom tube 68, a head tube 70 and a seat tube 72.

It should be noted that in FIG. 4 the front wheel 62 of the bicycle 2 is accommodated and held in the space 24 of the holding device 1 although alternatively and obviously the rear wheel 62 of the bicycle 2 can also be accommodated and held in the space 24 of the holding device 1, which in many cases forms an even more stable variant. The holding device 1 which is in the configurations illustrated in FIGS. 3 and 4, can also be configured, for example, in the manner illustrated and explained with reference to FIGS. 1 and 2.

FIG. 5 shows an overhead view of two bicycles 2, each of which is held on a wall 4 by means of a holding device 1 according to the invention and illustrated purely by way of example.

In contrast to FIG. 4, by way of example the rear wheel 62 of the respective bicycle 2 is held in the space 24 of the holding device 1.

The two holding devices 1 illustrated by way of example in FIG. 5 differ from the holding devices 1 illustrated in FIGS. 1 and 2—for example—essentially in that there is an additional holding element 74 or 76 respectively. This holding element 74 or 76 is connected with the holding device 1, which is here shown, as in FIGS. 1 and 2, with a U-shape by way of example. This connection can be non-detachable. Alternatively, however, it can also be detachable, for example to make it possible to attach a holding element 74 or 76 with a different design to the holding device 1 in question and thereby make possible a different configuration of the bicycle or bicycles 2. To use the detachable holding elements mentioned above, for example, the mounting hole 30 can remain in place, although otherwise it can also be omitted.

Here the holding element 74 is designed by way of example as a right-angled element, as a result of which, for example, an arrangement of the bicycle 2 with its plane defined by the top tube 66 and/or bottom tube 68, head tube 70 and seat tube 72 parallel to the wall 4 becomes possible. This bracket can be detachable (e.g. bolted on) or non-detachable (e.g. welded to the holding device 1, and specifically to the connecting leg 26 of the holding device 1).

Here, the holding element 76 is designed by way of example in the form of an acute-angle bracket element or as a plate molded or attached (e.g. welded) at an acute angle (for example, on the connecting leg 26 or the transition from the connecting leg 26 to the second leg 22, as a result of which, for example, an orientation of the bicycle 2 with its plane defined by the top tube 66 and/or bottom tube 68, head tube 70 and seat tube 72 at an angle to the wall 4 becomes possible. This holding element 76 bracket can be detachably (e.g. by means of screws) or non-detachably (e.g. welded) to the holding device 1, and specifically in particular to the connecting leg 26 of the holding device 1 or to the above-mentioned transition. The angle at which the bicycle 2 is placed with reference to the wall is thereby a function of the angle of the acute-angle bracket element or the angle at which the plate is molded on.

### REFERENCE NUMBERS

1 Holding device
2 Bicycle
3 Object
45 Wall
5 Floor, floor covering section
10 Mounting of 1
12 First brush of 1
14 Second brush of 1
16 Holder section of 1
18 Holder section of 1
20 First leg
22 Second leg
24 Space
26 Connecting leg
28 U-shaped part
30 Mounting hold
32 Fastening element, screw
34 Screw
36 Screw
38 Screw
40 Screw
42 First bristle of 12
44 First support structure of 12
46 Second bristle of 14
48 Second support structure of 14
50 First bristle bundle of 12
52 Second bristle bundle of 14
54 First length of 42
56 Second length of 42
58 First length of 46
60 Second length of 46
62 Rear wheel of 2
64 Front wheel of 2
66 Top tube
68 Bottom tube
70 Head tube
72 Seat tube
74 Holding element
76 Holding element

1. A brush-based holding device for bicycles (2), wherein the holding device (1) comprises:
a mounting (10), and
a plurality of bristles (42, 46) and/or blades that are supported by means of the mounting (10);
wherein the mounting (10) has two facing holder sections (16, 18), between which a space (24) is formed for the accommodation of a wheel of a bicycle (2) and
wherein at least a portion of the bristles (42, 46) and/or blades project, each with at least one free end, into this space (24);
wherein first bristles (42) and/or blades of the plurality of bristles (42, 46) and/or blades project from the direction of and/or from the one of the two facing holding sections (16, 18) with their free ends into this space (24), which is formed for the accommodation of a wheel of a bicycle (2) between two facing holder sections (16, 18), and that second bristles (46) and/or blades of the plurality of bristles (42, 46) and/or blades project from the direction of or from the other of the two facing holder sections (16, 18) with their free ends into this space (24), which is formed for the accommodation of a wheel of a bicycle (2) between two facing holder sections (16, 18);
characterized in that a plurality of first bristles (42) and/or blades project farther into this space (24) which is designed to accommodate a wheel of a bicycle (2) between two facing holder sections (16, 18), than a plurality of other first bristles (42) and/or blades, and/or that a plurality of second bristles (46) and/or blades project father into this space (24), which is designed to accommodate a wheel of a bicycle (2) between two facing holding sections (16, 18) than a plurality of other second bristles (46) and/or blades;
wherein the mounting (10) is formed by means of a U-shaped part (28), wherein this U-shaped part (28) has two facing legs (20, 22) and a connecting leg (26) that is oriented transversely with respect to the two facing legs (20, 22) and connects the two facing legs (20, 22).

2. A holding device as recited in claim 1, characterized in that between the free ends of the first bristles (42) and/or blades and the free ends of the second bristles (46) and/or blades, there is an intervening space free of bristles and/or blades, and namely viewed in the direction of the longitudinal extension of these bristles (42, 46) and/or blades in the state in which no external load is being applied to them.

3. A holding device as recited in in claim 1, characterized in that a plurality of first bristles (42) and/or blades overlap with a plurality of second bristles (46) and/or blades, and specifically viewed in the direction of the longitudinal extension of these first bristles (42) and/or blades and/or in the direction of the longitudinal extension of these second bristles (46) and/or blades in the state in which no external load is being applied to the bristles (42, 46) and/or blades.

4. A holding device as recited in claim 1, characterized in that the holding device (1) also has a first supporting structure (44) as well as a second supporting structure (48), wherein the first bristles (42) and/or blades are fastened on or in the first supporting structure (44), and wherein the second bristles (46) and/or blades are fastened on or in the second supporting structure (48).

5. A holding device as recited in claim 4, characterized in that the first supporting structure (44) is supported by a first of the two facing holder sections (16, 18) of the mounting (10), and that the second supporting structure (48) is supported by a second of the two facing holder sections (16, 18) of the mounting (10).

6. A holding device as recited in claim 1, characterized in that the mounting (10) is elastic so that the two facing holder sections (16, 18) of the mounting (10) and/or the two facing legs (20, 22) of the U-shaped part (28) can move at least partly toward each other and/or away from each other.

7. A bicycle holding device comprising:
at least one floor covering section (5); and
a holding device for bicycles (2);
wherein this holding device is fastened to the at least one floor covering section (5) by means of at least one fastening element (32),
characterized in that the holding device (1) is realized as recited in claim 1.

8. A bicycle holding device comprising:
at least one upright wall (4) and
a holding device for bicycles (2);
wherein the holding device (1) is fastened by means of at least one fastening element (32) to the upright wall (4),
characterized in that the holding device is realized as recited in claim 1.

9. A method for parking a bicycle in a held position, in which the bicycle (2) is supported with one or both wheels of the bicycle (2) on the bottom and/or on a foundation and in an essentially upright position, with the following steps:
providing at least one holding device for bicycles (2) as recited in claim 1.

10-15. (canceled)
